(19) United States
(12) Patent Application Publication
(10) Pub. No.: US 2012/0278305 A1
(43) Pub. Date: Nov. 1, 2012

(54) DYNAMIC MERGING OF EXECUTABLE STRUCTURES IN A DATABASE SYSTEM

(75) Inventors: Ke Wei Wei, Beijing (CN); Xin Ying Yang, Beijing (CN); Xiang Zhou, Beijing (CN)

(73) Assignee: INTERNATIONAL BUSINESS MACHINES CORPORATION, Armonk, NY (US)

(21) Appl. No.: 13/443,941

(22) Filed: Apr. 11, 2012

(30) Foreign Application Priority Data
Apr. 28, 2011 (CN) 201110116037.7

(51) Int. Cl. G06F 17/30

(52) U.S. Cl. 707/713; 707/E17.017

(57) ABSTRACT

Embodiments of the present invention relate to dynamically merging executable structures in a database system. In one embodiment, there is provided a method of dynamically merging executable structures in a database system that includes, in response to a query to the database system, extracting a stem and a branch of a query statement. The query statement includes query conditions, and the branch includes at least a subset of the query conditions. An executable structure of the stem is obtained from a cache of the database system, and an executable structure of the branch is generated. The executable structure of the stem and the executable structure of the branch are merged into a runtime executable structure.

### PRIORITY

The present application claims priority to Chinese Patent Application No. 201110116037.7, filed Apr. 28, 2011, and all the benefits accruing therefrom under 35 U.S.C. §119, the contents of which in its entirety are herein incorporated by reference.

### BACKGROUND

The present invention relates to database management, and more particularly, to dynamically merging executable structures in a database system.

The development of database technology provides increasingly large storage capacity, and a user may query storage and obtain required data by means of networks and the like. During a query to a database, when a query statement (written, for example, in Structured Query Language (SQL)) is received from a client, it is necessary to perform steps on the query statement such as syntactical analysis, pre-compiling and optimization before an executable structure may be generated. In general, an executable structure is the “executable” data during a query, and only after the query statement is finally converted into an executable structure can the query be executed. Accordingly, the speed of generating executable structures has become one of the key factors that affect query efficiency.

Caches dedicated to database management systems have been developed for the purpose of improving query efficiency. During operations of the database systems, previous query statements and executable structures generated from those query statements are cached. In subsequent queries, if a current query statement is found to be identical to a query statement that was previously cached (for example, by determining whether the two query statements are identical by means of matching their character strings), then a corresponding executable structure may be obtained directly. This manner of using cache technology has improved the efficiency of data queries to a great extent.

However, objects and conditions of queries have been increasingly diversified with the evolution of dynamic SQL. Thus, hit rates in the cache have been reduced, and again, steps such as syntactical analysis, pre-compiling and optimization must be implemented with regard to a new query statement, and then an executable structure may be generated. When determining whether the cache is hit by the query from the user, contemporary solutions can only determine whether a hit occurs by means of a simple text match, such as a string match, in the query statement. Although the prior art has provided technologies that can replace constant values, such as numbers in the query statement, with wildcards, a new executable structure must be generated with respect to a query when the query statement is modified by adding a new query condition or a formula such as a function that requires additional calculation.

A large number of similar query statements (for example, where the major portions of the query statements are identical and only portions of the query conditions are different) may exist in the cache. In this regard, there are many repetitive data in the executable structures corresponding to similar query statements. This repetitive data may be considered “redundant data,” which occupies valuable storage space in the cache. In contemporary systems, no dynamic solution is provided for reducing the amount of redundant data by, for example, dynamically adapting the existing executable structures to new query statements.

### SUMMARY

According to an exemplary embodiment of the present invention, there is provided a method of dynamically merging executable structures in a database system. The method includes, in response to a query to the database system, extracting a stem and a branch of a query statement. The query statement includes query conditions, and the branch includes at least a subset of the query conditions. An executable structure of the stem is obtained from a cache of the database system, and an executable structure of the branch is generated. The executable structure of the stem and the executable structure of the branch are merged into a runtime executable structure.

According to another exemplary embodiment of the present invention, there is provided a computer program product for dynamically merging executable structures in a database system. The computer program product includes a computer readable storage medium having computer readable program code embodied therewith. The computer readable program code includes computer readable program code configured for, in response to a query to the database system, extracting a stem and a branch of a query statement. The query statement includes query conditions, and the branch includes at least a subset of the query conditions. An executable structure of the stem is obtained from a cache of the database system, and an executable structure of the branch is generated. The executable structure of the stem and the executable structure of the branch are merged into a runtime executable structure.

According to a further exemplary embodiment of the present invention, an apparatus for dynamically merging executable structures in a database system is provided. The apparatus includes a processor and the apparatus is configured for, in response to a query to the database system, extracting a stem and a branch of a query statement. The query statement includes query conditions, and the branch includes at least a subset of the query conditions. An executable structure of the stem is obtained from a cache of the database system, and an executable structure of the branch is generated. The executable structure of the stem and the executable structure of the branch are merged into a runtime executable structure.

### BRIEF DESCRIPTION OF THE SEVERAL VIEWS OF THE DRAWINGS

Features, advantages, and other aspects of various embodiments of the present invention will become more apparent through the following detailed description with reference to the following drawings, wherein:

FIG. 1 schematically illustrates a diagram of a method of using cached executable structures in a database system;

FIG. 2 schematically illustrates a high level flowchart of a method according to one embodiment of the present invention;

FIG. 3 schematically illustrates a detailed flowchart of a method according to one embodiment of the present invention;

FIG. 4 schematically illustrates a diagram of a cached executable structure according to one embodiment of the present invention;

FIGS. 5A and 5B schematically illustrate diagrams of the executable structure of Query Statement 1, where FIG. 5A indicates an existing executable structure and FIG. 5B indicates a dynamically merged executable structure according to one embodiment of the present invention;

FIGS. 6A and 6B schematically illustrate diagrams of the executable structure of Query Statement 2, where FIG. 6A indicates an existing executable structure and FIG. 6B indicates a dynamically merged executable structure according to one embodiment of the present invention;

FIGS. 7A and 7B schematically illustrate diagrams of the executable structure of Query Statement 3, where FIG. 7A indicates an existing executable structure and FIG. 7B indicates a dynamically merged executable structure according to one embodiment of the present invention; and

FIG. 8 schematically illustrates a block diagram of an apparatus according to one embodiment of the present invention.

### DETAILED DESCRIPTION

Hereinafter, various embodiments of the present invention will be described in detail with reference to the drawings. The flowcharts and block diagrams in the figures illustrate the system and methods, as well as architecture, functions and operations executable by using a computer program product according to embodiments of the present invention. In this regard, each block in the flowcharts or block diagrams may represent a module, a program segment, or a part of code, which contains one or more executable instructions for performing specified logic functions. It should be noted that, in some alternative implementations, the functions noted in the blocks may also occur in a sequence different from what is noted in the drawings. For example, two blocks shown consecutively may be performed substantially in parallel or in an inverse order. It should also be noted that each block in the block diagrams and/or flowcharts and a combination of blocks in the block diagrams and/or flowcharts may be implemented by a dedicated hardware-based system for performing specified functions or operations or by a combination of dedicated hardware and computer instructions.

Embodiments of the present invention provide a method, apparatus, and computer program product for dynamically merging executable structures in a database system. This allows executable structures stored in cache to be reused in order to accelerate the response speed of data queries. In addition, embodiments allow for a reduction in the amount of redundant data in the cache so as to improve the effective utilization rate of the cache.

In one embodiment of the present invention, the executable structures are dynamically merged. The executable structures in the cache are reused by looking for an association relationship between a current query statement and the respective query statements corresponding to the executable structures in the cache, so as to improve the query efficiency.

Hereinafter, the principle and spirit of the present invention will be described with reference to various exemplary embodiments. It should be understood that these embodiments are provided only to enable those skilled in the art to better understand and further implement embodiments of the present invention, and are not intended to limit the scope of embodiments of the present invention in any manner.

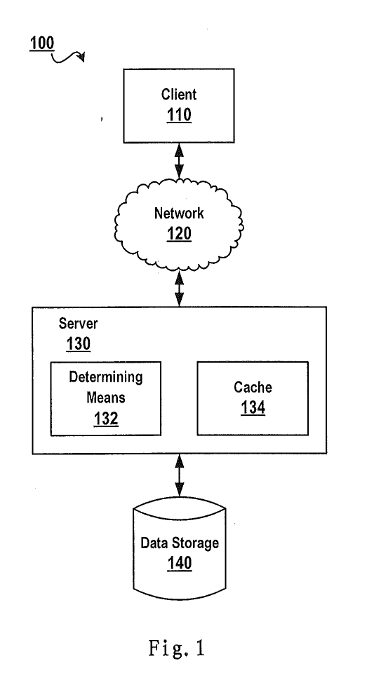

FIG. 1 schematically illustrates a diagram 100 of a method of using cached executable structures in a database system. As illustrated in FIG. 1, a cache 134 may be disposed at a server 130 so as to accelerate the response speed during a query to the database from a user. For example, when a user at a client 110 is accessing data storage 140 through a network 120, a determining means 132 in the server 130 first determines whether an executable structure that matches the query statement from the user is stored in the cache 134 (i.e., the determining means 132 determines whether the cache 134 is hit by the query from the user). In this example, if the cache 134 is hit, then the executable structure in the cache 134 is called directly to execute the query; otherwise, it is required to generate an executable structure corresponding to the query statement.

For the convenience of description below, several examples of query statements written in Structured Query Language (SQL) are illustrated in Table 1.

TABLE 1
Examples of Query Statements

| No. | Name | Query Statement |
|---|---|---|
| 1 | Query Statement 0 | SELECT COL1 FROM TB1 |
| | | WHERE COL1<25 |
| | | AND COL2=‘CAT’ |
| | | AND COL3=‘2011-01-01’ |
| 2 | Query Statement 1 | SELECT COL1 FROM TB1 |
| | | WHERE COL1<25 |
| | | AND COL2=‘CAT’ |
| | | AND COL3=‘2011-01-01’ |
| | | AND COL4=1.1 |
| 3 | Query Statement 2 | SELECT COL1 FROM TB1 |
| | | WHERE COL1<23 |
| | | AND COL2=SUBSTR(‘CATE’,1,3) |
| | | AND COL3=‘2011-08-23’ |
| 4 | Query Statement 3 | SELECT COL1 FROM TB1 |
| | | WHERE COL1<TAN(1.57) |
| | | AND COL2=SUBSTR(‘CATE’,1,3) |
| | | AND COL3=‘2011-08-06’ |
| 5 | Query Statement 4 | SELECT COL1 FROM TB2 |
| | | WHERE COL1<25 |
| | | AND COL2=‘CAT’ |
| | | AND COL3=‘2011-01-01’ |
| 6 | Query Statement 5 | SELECT COL1 FROM TB1, TB2 |
| | | WHERE TB1.COL1=TB2.COL2 |
| | | AND COL1<25 |
| | | AND COL2=‘CAT’ |
| | | AND COL3=‘2011-01-01’ |

Hereafter, the embodiments of the present invention are described according to the query statements illustrated in Table 1. The context of the application here is that Query Statement 0 has already been executed and the executable structure of Query Statement 0 has already been cached. The Query Statements 1 to 5 are to be executed. Before execution, it is required to determine whether the executable structures of the query statements in cache may be reused.

In the system illustrated in FIG. 1, the determination as to whether the cache 134 is hit is made by means of a character match. If the current query statement has been changed slightly, then the cache 134 as illustrated in FIG. 1 cannot provide any improvement to the query speed. In the query statements as illustrated in Table 1, the query conditions are indicated by predicates. For example, Query Statement 0 includes predicates such as “COL1<25,” “COL2=‘CAT’” and “COL3=‘2011-01-01’” that are connected by logical operators “AND.” For the convenience of description below, the respective predicates in the query statement are referred to in sequence as a first predicate, a second predicate . . . and so on. With regard to “COL1<25,” a predicate may include three parts: column name “COL1” on the left, conditional operator “<” in the middle and value “25” on the right. It should be noted that the values are not limited to constant items such as numbers, strings and dates, but may include functions with various types of returned values or even column names.

The major portions of Query Statements 1 to 3 are similar to Query Statement 0. The difference is that, Query Statement 1 further includes an additional predicate “COL4=1.1,” the second predicate of Query Statement 2 includes a function SUBSTR(‘CATE’,1,3), and the third predicate of the Query Statement 3 includes functions TAN(1.57) and SUBSTR(‘CATE’,1,3). In the prior art, new executable structures would have to be generated for the above query statements that include additional predicates or predicates including functions.

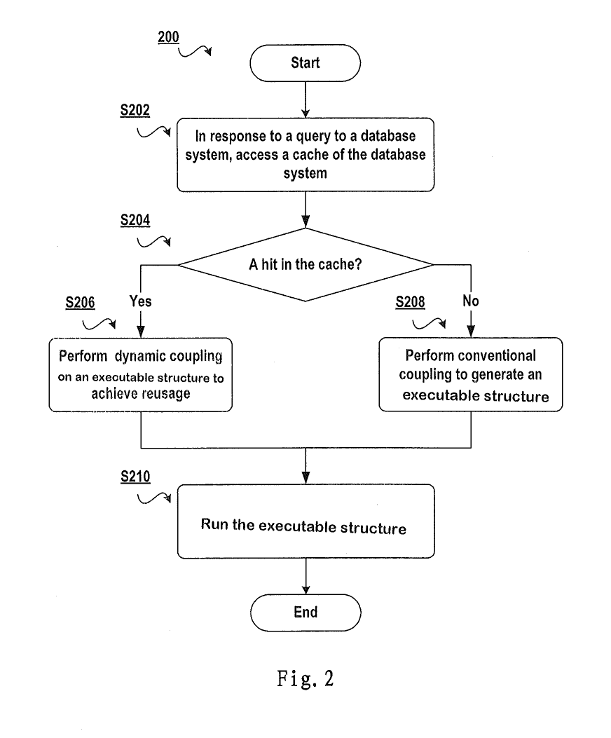

FIG. 2 schematically illustrates a high level flowchart 200 of a method according to one embodiment of the present invention. At block 5202, a cache of a database system is accessed in response to a query to the database system. At block 5204, it is determined whether the cache is hit. If a hit occurs in the cache, then the operation proceeds to block 5206 to perform dynamic merging according to embodiments of the present invention; otherwise, the operation proceeds to block 5208 to perform conventional merging to generate a corresponding executable structure. At block 5210, the executable structure (the reused executable structure from block 5206 or the conventional executable structure generated from block 5208) is run.

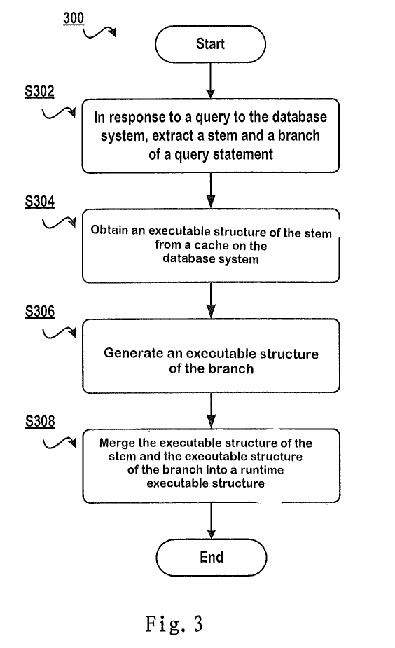

Hereinafter, methods and apparatuses according to embodiments of the present invention are detailed with reference to FIGS. 3 to 8. FIG. 3 schematically illustrates a detailed flowchart 300 of a method according to one embodiment of the present invention. At block S302, a stem and a branch of a query statement are extracted in response to a query to the database system. The whole query statement includes a combination of the stem and the branch of the query statement. The stem is associated with an existing executable structure in the cache which is a reusable part. The branch includes at least one part of the query conditions, and existing executable structures in the cache do not match the part of the query conditions specified by the branch.

Next, at block S304, an executable structure of the stem is obtained from a cache of the database system. Because the stem corresponds to a reusable executable structure in the cache, the executable structure of the stem is easily obtained from the cache of the database through simple operations and adapted accordingly. At this point, it is simply required to generate the executable structure of the branch and merge both of the executable structures.

At block S306, an executable structure of the branch is generated. It should be noted that in one embodiment, more of the query conditions are in the stem than in the branch. The query conditions involved in the stem may be achieved by reusing the executable structures in the cache, and the executable structure for the branch is generated during the query. It does not take a long time to generate an executable structure for the branch because typically there are few query conditions in the branch.

Finally, at block S308, the executable structure of the stem and the executable structure of the branch are merged into a runtime executable structure. Compared with the time spent in generating a new executable structure for a query statement when a miss occurs in the cache in contemporary systems, it takes much less time to perform the dividing, obtaining, generating and merging in blocks S302 to S308. Further, the storage efficiency in the cache is improved, and executable structures of query statements that are most beneficial for increasing the hit rate are stored in the cache.

In one embodiment, rules on how to divide the stem and the branch may be specified. For example, if the overall overhead of reusing the executable structure in the cache is approximate to or even greater than that of generating a new executable structure, a new executable structure may be generated directly.

Now, references are made to the query statements illustrated in Table 1, examples of stem and branch will be explained. In Query Statement 0 as illustrated in Table 1, the three predicates indicate three query conditions such as “COL1<25,” “COL2=‘CAT’” and “COL3=‘2011-01-01’,” respectively. Query Statement 1 further includes a fourth predicate “COL4=1.1” besides the three predicates identical to those of Query Statement 0. In this regard, if the executable structure of Query Statement 0 has already been cached, then the fourth predicate in Query Statement 1 may be specified as the branch and the remaining portion may be specified as the stem. In this regard, the time for generating an executable structure may be reduced by reusing the executable structures in the cache.

In another example, by comparing Query Statement 0 with Query Statement 2, it is known that the column names and conditional operators for the three predicates of Query Statements 0 and 2 are the same, and the difference is that the “value” in the second predicate is a function “SUBSTR( )” This function represents an operation of calculating sub-strings, i.e., obtaining 3 characters starting with the first character in the string “CATE.” It is known that the calculated result of “SUBSTR(‘CATE’,1,3)” is ‘CAT.’. With respect to Query Statement 2, the function in the second predicate may be specified as the branch. Similar to Query Statement 2, in the query conditions of Query Statement 3, the “value” in the first predicate is the function “TAN(1.57)” with a constant returned value, the “value” in the second predicate is the function “SUBSTR(‘CATE’,1,3)” with a constant returned value. With respect to Query Statement 3, the functions in the first and the second predicates may be specified as the branches.

In one embodiment, at least one part of the query conditions is independent of the cache. According to the rules for the division of stem and branch, one goal of the division of the stem and branch is to reuse the executable structures in the cache as much as possible. Then the executable structures that cannot be obtained directly from the cache are generated separately.

In one embodiment, the query conditions include at least one of a constant predicate in the query statement and an additional predicate in the query statement. With respect to the meaning of the constant predicate, it includes predicates including functions with a constant result, for example, the second predicate of the above Query Statement 2 “COL2=SUBSTR(‘CATE’,1,3),” the first and the second predicates of the Query Statement 3 “COL1<TAN(1.57)” and “COL2=SUBSTR(‘CATE’,1,3).” It should be noted that illustrations in the description are only examples of the constant predicates, while the column names, conditional operators and functions may vary according to various kinds of requirements. For example, the column name may be any column name of a table in the database, the conditional operator may include, but is limited to: any conditional operators such as “>, <, =, ≧, ≦, ≠” and the like; and the functions may include, but are not limited to: mathematical functions (for example, TAN( ) SIN( )), functions of character strings (for example, SUBSTR( )), and various other kinds of functions known to those skilled in the art.

In one embodiment of the present invention, in response to a query to the database system, extracting the stem and the branch of the query statement includes: replacing a constant item in the query statement with a wildcard to form a unified expression; selecting a cached statement corresponding to at least one executable structure in the cache; and determining the stem and the branch by comparing the unified expression with the cached statement.

In this embodiment, the term “constant items” should be construed as including not only common constants (for example, numbers, strings and dates, etc.) but also functions with a constant value as the calculated result. It should be noted that, the expressions of the cached statements are the same as those of the unified expressions, that is, the constant items in the query statements should also be replaced with wildcards. Hereinafter, Table 2 illustrates a Cached Statement (corresponding to the original Query Statement 0) and Unified Expressions 1 to 5 (corresponding to the Query Statements 1 to 5 respectively).

TABLE 2
Examples of Unified Expressions

| No. | Name | Unified Expression |
|---|---|---|
| 1 | Cached Statement | SELECT COL1 FROM TB1 |
| | | WHERE COL1<$ |
| | | AND COL2=$ |
| | | AND COL3=$ |
| 2 | Unified Expression 1 | SELECT COL1 FROM TB1 |
| | | WHERE COL1<$ |
| | | AND COL2=$ |
| | | AND COL3=$ |
| | | AND COL4=$ |
| 3 | Unified Expression 2 | SELECT COL1 FROM TB1 |
| | | WHERE COL1<$ |
| | | AND COL2=$ |
| | | AND COL3=$ |
| 4 | Unified Expression 3 | SELECT COL1 FROM TB1 |
| | | WHERE COL1<$ |
| | | AND COL2=$ |
| | | AND COL3=$ |
| 5 | Unified Expression 4 | SELECT COL1 FROM TB2 |
| | | WHERE COL1<$ |
| | | AND COL2=$ |
| | | AND COL3=$ |
| 6 | Unified Expression 5 | SELECT COL1 FROM TB1, TB2 |
| | | WHERE TB1.COL1=TB2.COL2 |
| | | AND COL1<$ |
| | | AND COL2=$ |
| | | AND COL3=$ |

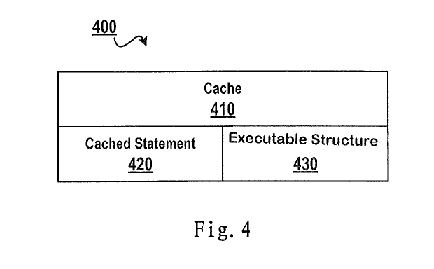

FIG. 4 schematically illustrates a diagram 400 of a cached executable structure according to one embodiment of the present invention. In this embodiment, a cache 410 includes two portions, i.e. a cached statement 420 and an executable structure 430, which may be represented by a two-tuple (the cached statement 420, the executable structure 430). For example, given the database system is just started and the cache 410 is empty, an executable structure corresponding to Query Statement 0 is generated when Query Statement 0 is applied to query the database system.

In one embodiment, when extracting the stem and the branch of the query statement, it is necessary to maintain in the cache 410 only the cached statements with the constant items having been replaced with wildcards, because the specific content of the “value” in the predicates may not be concerned. With the growth of the number of the queries, the number of the two-tuples (the cached statement, the executable structure) in the cache 410 will increase, and the content of those two-tuples will be updated with the queries. The method of updating depends on a policy for updating the cache. For example, a principle of least recently used (LRU) may be adopted.

It should be noted that, the data structure for storing the cached statement 420 and the executable structure 430 in a two-tuple as illustrated in FIG. 4 is just an exemplary illustration, and those skilled in the art can also apply other ways for storing. For example, a triple (a query statement, a cached statement, an executable structure) may be used for storing, and a storage area may be disposed in memories other than in the cache 410 and used for storing the cached statements, meanwhile corresponding relationships are built between each cached statement and the corresponding executable structure.

By comparing the Cached Statement and the Unified Expressions 1 to 3 illustrated in Table 2, it can be seen that the difference between the Unified Expression 1 and the Cached Statement is that a fourth predicate is added after the wildcard replacement. Although the Query Statements 1 to 3 are different from Query Statement 0 (values in the predicates are different), their major portions are similar. The operation of wildcard replacement removes the minor difference between the query statements and the cached statements, and reflects more of the similarity among the Query Statements 1 to 3.

In one embodiment, the stem and the branch of a query statement are determined by comparing the cached statements with the unified expression of the current query statement to determine the stem and branch quickly. One key to quick determination of the stem and branch is the selection from the cache of a cached statement that can be specified as the stem. In one embodiment, obtaining a cached statement corresponding to one of at least one executable structure in the cache includes recommending the cached statement based on at least one of: utilization frequency of the at least one executable structure in the cache; execution performance of the at least one executable structure in the cache; and complexity in generating the executable structure of the branch.

In one embodiment, utilization frequency of respective executable structures in the cache may be counted and cached statements corresponding to executable structures with high frequency of utilization are recommended. In another example, it may be desirable to reuse the executable structures in the cache in order to improve the query efficiency; thus, the cached statement corresponding to the executable structure with the highest efficiency of execution may be recommended. In yet another example, because the executable structure of the stem and the executable structure of the branch are merged into a runtime executable structure, complexity in generating the executable structure of the branch should be considered in addition to various factors related to the stem. Generally, the complexity in generating the executable structure of the branch becomes a bottleneck that affects the query speed; thus, the cached statement which reduces the complexity in generating the executable structure of the branch to the lowest level, may be recommended.

In one embodiment, each of the rules mentioned above are considered in balance, for example, weights are set to respective elements of the recommendation rules, and a method such as a weighted sum and the like are applied to recommend the cached statement with the highest score.

In one embodiment, the determining the stem and the branch by comparing the unified expression with the cached statement includes: in response to determining that the unified expression is a superset of or exactly matches the cached statement, specifying a portion of the query statement that corresponds to the cached expression as the stem, and specifying the remaining portion of the query statement as the branch.

The so-called superset here is an opposite concept of a subset. If each and every element of the cached statements are in the unified expressions and the unified expressions further include another element that is not included in the cached statements, then the set of the unified expressions is a superset of the set of cached statements. It should be noted that the element referred to herein is an element with syntax meaning in SQL (for example, keywords in SQL, table names in the database, logical operators and predicates, etc., and it should be noted that values in predicates have already been replaced with wildcards), instead of strings being composed of each character in the unified expression.

For example, because Unified Expression 1 is a superset of the Cached Statement, the portion corresponding to the Cached Statement in Unified Expression 1 is specified as the stem and the fourth predicate “COL4=$4” subsequent to wildcard replacement is specified as the branch. For example, if Unified Expression 2 exactly matches the Cached Statement, then a portion of the query statement that corresponds to the cached expression may be specified as the stem, and predicate “COL2=SUBSTR(‘CATE’,1,3)” having been replaced during the procedure of wildcard replacement is specified as the branch.

In one embodiment, the determining that the unified expression is a superset of the cached statement includes: dividing the cached statement into a first portion and a second portion, where the first portion is a part of the cached statement excluding the predicate; when the unified expression is a superset of the first portion, determining whether the unified expression is a superset of the second portion; and in response to the unified expression being a superset of the second portion, determining that the unified expression is a superset of the cached statement.

If the unified expression is not a superset of the first portion, then it is impossible for the unified expression to be a superset of the cached statement. Thus, dividing the cached statement into the first portion and the second portion may accelerate the speed of determination. That is to say, it is unnecessary to consider the second portion if the unified expression is not a superset of the first portion in the cached statement. Examples are given below to explain how to divide a cached statement into a first portion and a second portion. With respect to the Cached Statement as illustrated in Table 2, divisions are shown below:

the first portion: SELECT COL1 FROM TB1

the second portion: WHERE COL1<$
AND COL2=$
AND COL3=$

For example, Unified Expression 4 as illustrated above in Table 2 indicates a query to the table of “TB2.” When determining whether Unified Expression 4 is a superset of the Cached Statement, first, the first portion of the Cached Statement (i.e., “SELECT COL1 FROM TB1”) is compared with Unified Expression 4, then it is known that Unified Expression 4 is not a superset of the Cached Statement (because the objects of both queries are different, and their objects are tables “TB2” and “TB1,” respectively).

For example, during determining whether Unified Expression 1 is a superset of the Cached Statement, it is found that Unified Expression 1 is a superset of the first portion, then that Unified Expression 1 is also a superset of the second portion. Accordingly, the conclusion is that Unified Expression 1 is a superset of the Cached Statement.

Also for example, when a query is performed on a plurality of tables in the database (for example, the Query Statement 5 queries tables “TB1” and “TB2”, respectively), a joint operation should be further performed. In this regard, the unified expression may be first compared to the first portion that is a part of the Cached Statement excluding the predicate. If the unified expression is not a superset of the first portion, then it is determined that the unified expression is not a superset of the Cached Statement directly without the need to compare it with the remaining portion.

In one embodiment, before the stem and the branch of the query statement are extracted, the query statement is normalized, and the normalized query statement is classified based on a type of a predicate in the query statement. It may be desirable to convert the query statement into a normalized format. For example, redundant spaces, tabs or return characters may be removed. In an embodiment, a goal of the subsequent classifying operation with respect to the normalized query statement is a pre-processing for generating the executable structure of the branch. For example, it is unnecessary to perform additional operations to a common constant predicate (predicate in which the value is a common constant); and it is necessary for a function constant predicate (predicate in which the value is a function with a constant returned value) to record information such as the name, parameters and the type of the returned value of the function, such that the information may be used for generating the executable structure later.

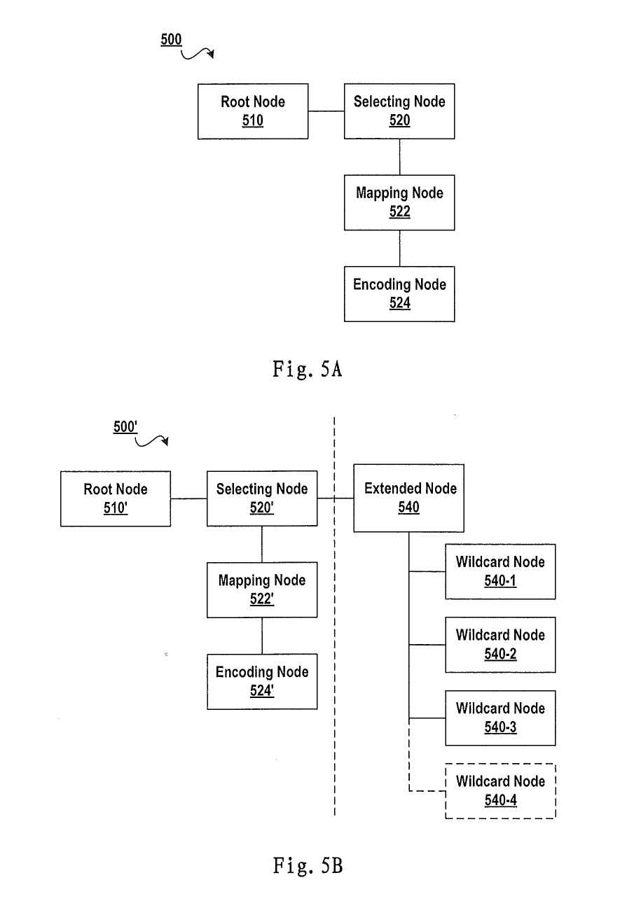

In one embodiment, the generating of an executable structure of the branch includes: creating condition nodes associated with each of the query conditions in the branch; and adding each of the condition nodes into the executable structure of the branch. Hereinafter, references are made to FIGS. 5A and 5B, and the processes of generating the executable structures are detailed.

FIGS. 5A and 5B schematically illustrate diagrams 500 500′ of the executable structure for Query Statement 1. In the existing executable structure 500, a root node 510 indicates an entry node to call the executable structure, a selecting node 520 includes various types of interactive parameters involved during the query, a mapping node 522 indicates a mapping relationship between an internal format and an external format of respect parameter, and an encoding node 524 indicates which encoding schema is applied. It should be noted that, FIG. 5A is only a general illustration of the executable structure, and the executable structure may utilize different hierarchy structures in the database system from various providers.

FIG. 5B indicates a dynamically merged executable structure 500′ according to one embodiment of the present invention. It should be noted that, a root node 510′, a selecting node 520′, a mapping node 522 and an encoding node 524′ correspond to respective nodes as illustrated in FIG. 5A, respectively, and the above nodes in the executable structure 500′ constitute the executable structure of the stem that is obtained from the cache of the database system.

Hereafter, examples of how to generate the executable structure of the branch are provided. First, an extended node 540 that indicates the executable structure of the branch is attached to the selecting node 520′, and wildcard nodes 540-1 to 540-4 associated with the respective predicates in Query Statement 1 are attached to the extended node 540, where each wildcard node includes information related to values that are replaced with wildcards in one predicate. For example, the wildcard 540-1 may comprise the information related to the first predicate “COL1<25” in Query Statement 1, the wildcard node 540-2 may include information related to the second predicate “COL2=‘CAT’” in Query Statement 1, and the wildcard 540-4 may include information related to the fourth predicate “COL1<25” (the additional predicate) in Query Statement 1. The node 540-4 that needs additional calculation is illustrated with a dotted line in FIG. 5B, and the node 540-4 is attached to the extended node 540 directly.

As illustrated in FIG. 5B, the executable structure is merged into the executable structure of the stem through the extended node 540. The portion to the left of the extended node 540 is the executable structure of the stem that is obtained from the cache. In this regard, it is only required to further generate the executable structure of the stem and merge the executable structure of the stem and the executable structure of the branch into a runtime executable structure. Compared with the method of generating a new executable structure when the cache is missed in the prior art, the embodiments of the present invention may reduce the time spent in generating the executable structure significantly and further increase query efficiency.

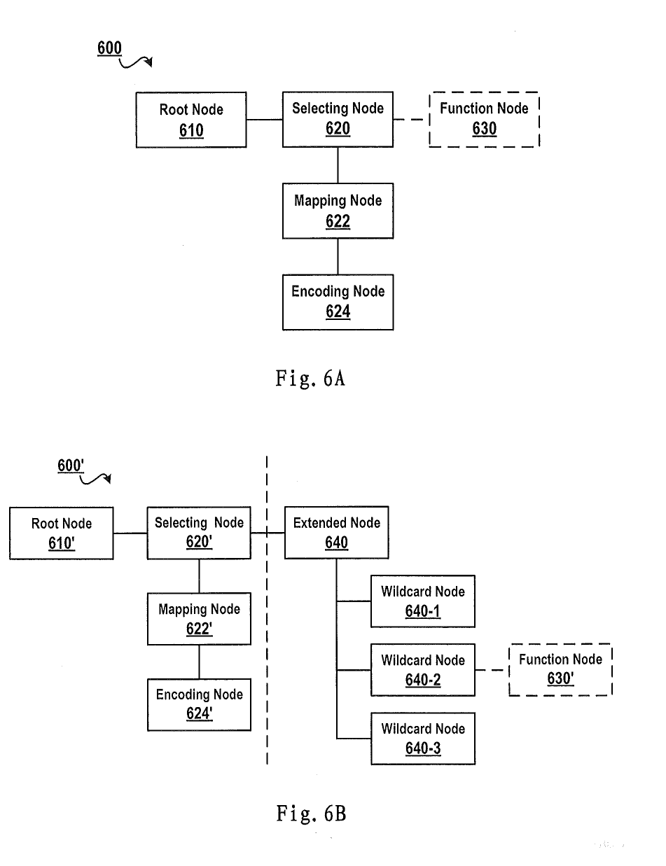

FIGS. 6A and 6B schematically illustrate diagrams 600 600′ of the executable structure of Query Statement 2. An executable structure 600 as illustrated in FIG. 6A is similar to the one as illustrated in FIG. 5A. The difference is that the executable structure 600 further includes a function node 630 (as illustrated in the dotted line block). A function node may include additional processes required for a query. With respect to Query Statement 2, the function node 630 may include the function “SUBSTR(‘CATE’,1,3)” in the second predicate, and the result as calculated from the function node 630 is a string ‘CAT’.

FIG. 6B indicates a dynamically merged executable structure 600′ according to one embodiment of the present invention, and the meanings of the extended node 640 and wildcard nodes 640-1 to 640-3 are similar to those as illustrated in FIG. 5B. The difference is that, a function node 630′ is attached to the wildcard node 640-2 of the second predicate directly because the function node 630′ corresponds to the second predicate.

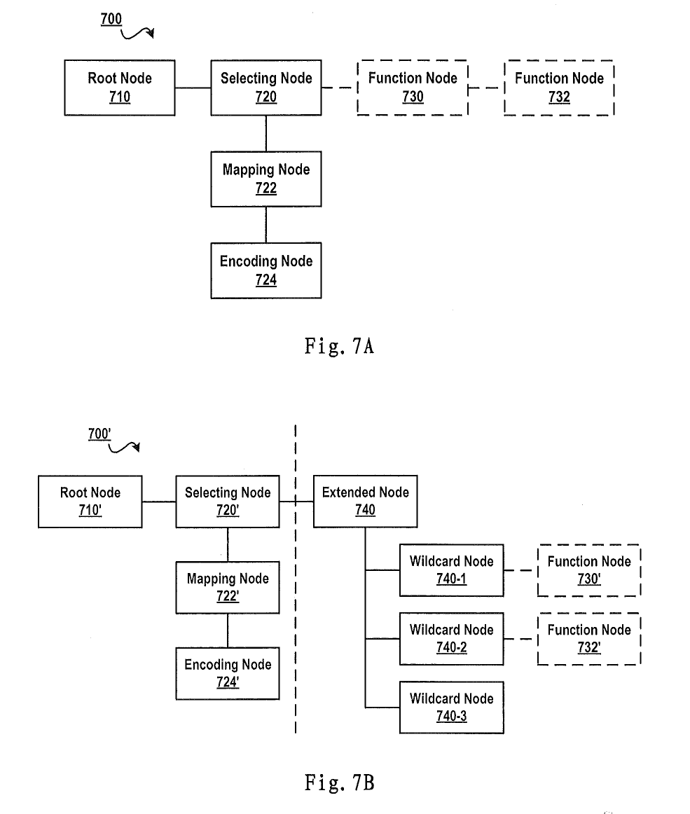

FIGS. 7A and 7B schematically illustrate diagrams 700 700′ of the executable structure of Query Statement 3, where FIG. 7A indicates an existing executable structure 700 and FIG. 7B indicates a dynamically merged executable structure 700′ according to one embodiment of the present invention. Two function nodes 730 and 732 are illustrated in FIG. 7A, respectively, because the first predicate and the second predicate in Query Statement 3 include two functions TAN(1.57) and SUBSTR(‘CATE’,1,3). Furthermore, in the executable structure 700′ subsequent to the dynamic merging, two function nodes 730′ and 732′ (as illustrated in dotted line blocks) are attached to the wildcard nodes 740-1 and 740-2, which will not be detailed here.

In one embodiment, the cache may be updated by using the query statement and the runtime executable structure. The executable structures in the cache continuously change with the execution of the query operations. One of the basic updating rules is that the executable structure with the most inactive level should be eliminated. For example, executable structures in the cache may be sorted based on their reuse times according to the historical statistics, and the cache may be updated with two-tuples of the current query statement and the runtime executable structure so as to replace the two-tuples of the executable structure with a relatively low ranking.

In one embodiment, a user may be provided with a query interface that includes a compulsory part and an optional part, and a query statement may be generated automatically upon query conditions having been entered by the user. In this regard, it may be specified that the executable structures corresponding to the compulsory part are resident in the cache.

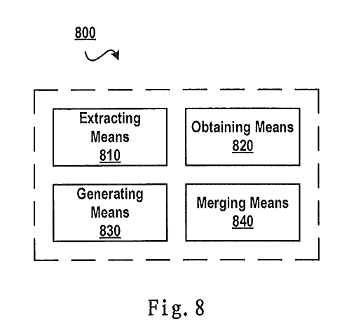

FIG. 8 schematically illustrates a block diagram 800 of an apparatus according to one embodiment of the present invention. The apparatus includes: extracting means 810 configured to extract a stem and a branch of a query statement in response to a query to the database system; obtaining means 820 configured to obtain an executable structure of the stem from a cache of the database system; generating means 830 configured to generate an executable structure of the branch; and merging means 840 configured to merge the executable structure of the stem and the executable structure of the branch into a runtime executable structure; wherein the branch comprises at least one part of query conditions of the query statement.

In another embodiment, the at least one part of the query conditions are independent of the cache.

In another embodiment, the query conditions include at least one of a constant predicate in the query statement and an additional predicate in the query statement.

In another embodiment, the extracting means includes: replacing means configured to replace a constant item in the query statement with a wildcard to form a unified expression; selecting means configured to select a cached statement corresponding to one of at least one executable structure in the cache; and determining means configured to determine the stem and the branch by comparing the unified expression with the cached statement.

In another embodiment, the selecting means includes recommending means configured to recommend the cached statement based on at least one of: utilization frequency of the at least one executable structure in the cache; execution performance of the at least one executable structure in the cache; and complexity in generating the executable structure of the branch.

In another embodiment, the determining means includes: specifying means configured to specify a portion of the query statement that corresponds to the cached expression as the stem in response to determining that the unified expression is a superset of or exactly matches the cached statement, and specifying the remaining portion of the query statement as the branch.

In another embodiment, the specifying means includes: means for dividing the cached statement into a first portion and a second portion, wherein the first portion is a part of the cached statement excluding the predicate; means for determining whether the unified expression is a superset of the second portion when the unified expression is a superset of the first portion; and means for determining that the unified expression is a superset of the cached statement in response to the unified expression being a superset of the second portion.

Another embodiment also includes: normalizing means configured to normalize the query statement; and classifying means configured to classify the normalized query statement based on a type of a predicate in the query statement.

In another embodiment, the generating means includes creating means configured to create condition nodes associated with each of the query conditions in the branch; and adding means configured to add each of the condition nodes into the executable structure of the branch.

Another embodiment further includes updating means configured to update the cache using the query statement and the runtime executable structure.

It should be noted that embodiments of the present invention are directed to a method, apparatus, and computer program product for dynamically merging executable structures in a database system. It should be noted, although embodiments are explained with reference to specific data structures, those skilled in the art can realize that application environments of the embodiments are not limited to the disclosure. For example, when combined with specific implements from various database providers, embodiments of the present invention may be implemented in a variety of application environments, such as those provided by IBM®, Oracle® and Microsoft®.

Embodiments of the present invention may adopt the form of a hardware embodiment, a software embodiment or an embodiment that includes both hardware components and software components. In one embodiment, an embodiment of the present invention is implemented as software such as, but limited to, firmware, resident software, and micro-code.

Moreover, embodiments of the present invention may be implemented as a computer program product usable from computers or accessible by computer-readable media that provide program code for use by or in connection with a computer or any instruction executing system. For the purpose of description, a computer-usable or computer-readable medium may be any tangible means that can contain, store, communicate, propagate, or transport the program for use by or in connection with an instruction execution system, apparatus, or device.

The medium may be an electric, magnetic, optical, electromagnetic, infrared, or semiconductor system (apparatus or device), or propagation medium. Examples of computer-readable mediums that are computer-readable storage mediums include the following: a semiconductor or solid storage device, a magnetic tape, a portable computer diskette, a random access memory (RAM), a read-only memory (ROM), a hard disk, and an optical disk. Examples of a current optical disk include a compact disk read-only memory (CD-ROM), compact disk-read/write (CR-ROM), and DVD.

A data processing system adapted for storing or executing program code may include at least one processor that is coupled to a memory element directly or via a system bus. The memory element may include a local memory usable when actually executing the program code, a mass memory, and a cache that provides temporary storage for at least one portion of program code so as to decrease the number of times for retrieving code from the mass memory during execution.

An input/output (I/O) device (including, but not limited to, a keyboard, a display, a pointing device, etc.) may be coupled to the system directly or via an intermediate I/O controller.

A network adapter may also be coupled to the system such that the data processing system can be coupled to other data processing systems, remote printers or storage devices via an intermediate private or public network. A modem, a cable modem, and an Ethernet card are merely examples of a currently usable network adapter.

It is to be understood from the foregoing description that modifications and alterations may be made to the respective embodiments of the present invention without departing from the true spirit of the present invention. The description in the present specification is intended to be illustrative and not limiting. The scope of the present invention is limited by the appended claims only.

1. A method of dynamically merging executable structures in a database system, the method comprising:
in response to a query to the database system, extracting a stem and a branch of a query statement, the query statement including query conditions and the branch including at least a subset of the query conditions;
obtaining an executable structure of the stem from a cache of the database system;
generating an executable structure of the branch; and
merging the executable structure of the stem and the executable structure of the branch into a runtime executable structure.

2. The method according to claim 1, wherein the at least a subset of the query conditions are independent of the cache.

3. The method according to claim 1, wherein the query conditions comprise at least one of a constant predicate in the query statement and an additional predicate in the query statement.

4. The method according to claim 1, wherein the extracting the stem and the branch of the query statement comprises:
replacing a constant item in the query statement with a wildcard to form a unified expression;
selecting a cached statement corresponding to one of at least one executable structure in the cache; and
determining the stem and the branch by comparing the unified expression with the cached statement.

5. The method according to claim 4, wherein the selecting a cached statement corresponding to one of at least one executable structure in the cache is based on at least one of:
utilization frequency of the at least one executable structure in the cache;
execution performance of the at least one executable structure in the cache; and
complexity in generating the executable structure of the branch.

6. The method according to claim 4, wherein the determining the stem and the branch by comparing the unified expression with the cached statement comprises:
in response to determining that the unified expression is a superset of or exactly matches the cached statement, specifying a portion of the query statement that corresponds to the cached expression as the stem, and specifying the remaining portion of the query statement as the branch.

7. The method according to claim 6, wherein the determining that the unified expression is a superset of or exactly matches the cached statement comprises:
dividing the cached statement into a first portion and a second portion, wherein the first portion is a part of the cached statement excluding the predicate;
based on the unified expression being a superset of or exactly matching the first portion, determining whether the unified expression is a superset of the second portion; and
based on the unified expression being a superset of or exactly matching the second portion, determining that the unified expression is a superset of the cached statement.

8. The method according to claim 1, wherein before extracting the stem and the branch of the query statement, the method further comprises:
normalizing the query statement; and
based on a type of a predicate in the query statement, classifying the normalized query statement.

9. The method according to claim 1, wherein the generating an executable structure of the branch comprises:
creating condition nodes associated with each of the query conditions in the branch; and
adding each of the condition nodes into the executable structure of the branch.

10. The method according to claim 1, further comprising
updating the cache using the query statement and the runtime executable structure.

11. A computer program product for dynamically merging executable structures in a database system, the computer program product comprising:
a computer readable storage medium having computer readable program code embodied therewith, the computer readable program code comprising:
computer readable program code configured for:
in response to a query to the database system, extracting a stem and a branch of a query statement, the query statement including query conditions and the branch including at least a subset of the query conditions;
obtaining an executable structure of the stem from a cache of the database system;
generating an executable structure of the branch; and
merging the executable structure of the stem and the executable structure of the branch into a runtime executable structure.

12. The computer program product according to claim 11, wherein the at least a subset of the query conditions are independent of the cache.

13. The computer program product according to claim 11, wherein the query conditions comprise at least one of a constant predicate in the query statement and an additional predicate in the query statement.

14. The computer program product according to claim 11, wherein the extracting the stem and the branch of the query statement comprises:
replacing a constant item in the query statement with a wildcard to form a unified expression;
selecting a cached statement corresponding to one of at least one executable structure in the cache; and
determining the stem and the branch by comparing the unified expression with the cached statement.

15. The computer program product according to claim 11, wherein the computer readable program code is further configured for:
before extracting the stem and the branch of the query statement:
normalizing the query statement; and
based on a type of a predicate in the query statement, classifying the normalized query statement.

16. The computer program product according to claim 11, wherein the generating an executable structure of the branch comprises:
creating condition nodes associated with each of the query conditions in the branch; and
adding each of the condition nodes into the executable structure of the branch.

17. The computer program product according to claim 11, wherein the computer readable program code is further configured for
updating the cache using the query statement and the runtime executable structure.

18. An apparatus for dynamically merging executable structures in a database system, the apparatus comprising a processor, the apparatus configured for:
in response to a query to the database system, extracting a stem and a branch of a query statement, the query statement including query conditions and the branch including at least a subset of the query conditions;
obtaining an executable structure of the stem from a cache of the database system;
generating an executable structure of the branch; and
merging the executable structure of the stem and the executable structure of the branch into a runtime executable structure.

19. The apparatus according to claim 18, wherein the extracting the stem and the branch of the query statement comprises:
replacing a constant item in the query statement with a wildcard to form a unified expression;
selecting a cached statement corresponding to one of at least one executable structure in the cache; and
determining the stem and the branch by comparing the unified expression with the cached statement.

20. The apparatus of claim 18, wherein the apparatus is further configured for:
before extracting the stem and the branch of the query statement:
normalizing the query statement; and
based on a type of a predicate in the query statement, classifying the normalized query statement.
